(19) United States
(12) Patent Application Publication
(10) Pub. No.: US 2023/0076959 A1
(43) Pub. Date: Mar. 9, 2023

(54) SYSTEM AND METHOD FOR SYNCHRONIZING PERFORMANCE EFFECTS WITH MUSICAL PERFORMANCE

(71) Applicant: Beatflo LLC, Austin, TX (US)

(72) Inventor: Ronald G White, Austin, TX (US)

(73) Assignee: Beatflo LLC, Austin, TX (US)

(21) Appl. No.: 17/458,679

(22) Filed: Aug. 27, 2021

(51) Int. Cl. G11B 27/00; G10H 1/00; H04N 5/05; H04N 5/268; G11B 27/10

(52) U.S. Cl. CPC G11B 27/005; G10H 1/0066; H04N 5/05; H04N 5/268; G11B 27/10; G10H 2210/076; G10H 2240/031

(57) ABSTRACT

A system and a method for synchronizing performance effects with a musical performance. The method includes receiving a MIDI signal representing an audio track currently being played; determining, in near real-time, a tempo value of the said audio track based on a corresponding clock speed information as obtained from the MIDI signal; receiving information about a video file selected to be played along with the said audio track; determining, in near real-time, a tempo value of the said video file based on the received information thereabout; processing the said video file to determine required playback speed adjustment therefor to cause the tempo value of the said video to be in sync with the determined tempo value of the said audio track; and playing the said video file with the required playback speed adjustment applied thereto, along with the audio track in the musical performance.

### TECHNICAL FIELD

The present disclosure relates generally to controlling musical performances and more specifically, to a method and a system for synchronizing performance effects with a musical performance.

### BACKGROUND

Over the years, the music industry has grown by leaps and bounds. Performances are held throughout the world and people pay hefty amount for viewing them. In order to attract more and more viewers by providing a rich experience, the performers may need to invest in visual effects and video files to be played during their performances. To enhance the performance experience, many musicians offer syncing of audio playback to video playback in music concert settings. However, it may be appreciated that organizing, instantly recalling, selecting and synchronizing a video playback (from thousands of videos files) to tempo of live music in real-time (i.e. during live stage and/or streaming performances) may be impossible for the performer or even for any performance support team. Furthermore, all the known methods for playing videos in synchronization with music, require dragging and dropping videos to a “grid” for manually triggered playback or at best triggering one video to another in the grid at some tempo. However, such methods only trigger the videos at a particular tempo, and the videos may not match in real time as the tempo changes.

Conventionally to achieve syncing of audio playback to video playback during stage and/or streaming performances, video files are pre-downloaded one by one according to the music to be played. Next a playlist would be created such that for a particular audio song in the musical performance, a corresponding video file with, generally, matching tempo (beats) is played. It may take weeks to organize such playlist, and further to edit videos to play at the correct speed (tempo) for synchronization. Moreover, typically, a dedicated person would be required to execute the video aspect of the performance. Such dedicated person may utilize a standalone computing device that may be solely dedicated to control video playback, while the musicians (i.e., the band or the DJ) would play on a separate computing system.

Therefore, in light of the foregoing discussion, there exists a need to overcome the aforementioned drawbacks associated with known techniques for synchronizing performance effects with a musical performance.

### SUMMARY

The present disclosure seeks to provide a system and a method for synchronizing performance effects with a musical performance. An aim of the present disclosure is to provide a solution that overcomes at least partially the problems encountered in prior art, and provides improved system and method for synchronizing performance effects with a musical performance. The present disclosure seeks to provide a solution to the existing problem of need to create a playlist of videos beforehand or in real time that matches with tempo of audio tracks to be played in a live musical performance. The present disclosure archives this by interpreting videos tempo and then time-stretching those videos to match the tempo of music playback in real-time.

In an aspect, the present disclosure provides, a method for synchronizing performance effects with a musical performance, the method comprising:
receiving a MIDI signal representing an audio track currently being played in the musical performance;
determining, in near real-time, a tempo value of the said audio track based on a corresponding clock speed information as obtained from the MIDI signal;
receiving information about a video file selected to be played along with the said audio track in the musical performance, as part of the performance effects;
determining, in near real-time, a tempo value of the said video file based on the received information thereabout;
processing the said video file to determine required playback speed adjustment therefor to cause the tempo value of the said video to be in sync with the determined tempo value of the said audio track; and
playing the said video file with the required playback speed adjustment applied thereto, along with the audio track in the musical performance.

In another aspect, the present disclosure provides, a system for synchronizing performance effects with a musical performance, the system comprising:
an audio application programming interface (audio API) configured to receive, from a music application, a MIDI signal representing an audio track currently being played in the musical performance;
a memory having a library of video files stored therein;
a user interface adapted to allow a user to select a video file, from the library of video files, selected to be played along with the said audio track in the musical performance, as part of the performance effects; and
a processor configured to:
   determine, in near real-time, a tempo value of the said audio track based on a corresponding clock speed information as obtained from the MIDI signal;
   determine, in near real-time, a tempo value of the said video file based on information thereabout; and
   process the said video file to determine required playback speed adjustment therefor to cause the tempo value of the said video to be in sync with the determined tempo value of the said audio track; and
a display configured to play the said video file with the required playback speed adjustment applied thereto, along with the audio track in the musical performance.

Embodiments of the present disclosure substantially eliminate or at least partially address the aforementioned problems in the prior art, and enable truthful synchronization of performance effects with the musical performance.

Additional aspects, advantages, features and objects of the present disclosure would be made apparent from the drawings and the detailed description of the illustrative implementations construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram illustration of a system for synchronizing performance effects with a musical performance, in accordance with an embodiment of the present disclosure;

FIG. 2 is a diagrammatic illustration of an exemplary user interface for synchronizing performance effects with the musical performance, in accordance with an embodiment of the present disclosure;

FIG. 3A is a diagrammatic illustration of an exemplary user interface of a media browser for managing video files and for synchronizing performance effects with the musical performance, in accordance with an embodiment of the present disclosure;

FIG. 3B is a diagrammatic illustration of an exemplary user interface of a control panel for synchronizing performance effects with the musical performance in a time mode, in accordance with an embodiment of the present disclosure;

FIG. 3C is a diagrammatic illustration of an exemplary user interface of a control panel for synchronizing performance effects with the musical performance in a BPM mode, in accordance with an embodiment of the present disclosure;

FIG. 4 is a diagrammatic illustration of an exemplary user interface for synchronizing performance effects with the musical performance in a micro-view form, in accordance with an embodiment of the present disclosure;

FIG. 5 is a diagrammatic illustration of an exemplary user interface for triggering actions with the musical performance, in accordance with an embodiment of the present disclosure; and

FIG. 6 is a block diagram illustration of a system for synchronizing performance effects with the musical performance, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In an aspect, the present disclosure provides, a method for synchronizing performance effects with a musical performance, the method comprising:
receiving a MIDI signal representing an audio track currently being played in the musical performance;
determining, in near real-time, a tempo value of the said audio track based on a corresponding clock speed information as obtained from the MIDI signal;
receiving information about a video file selected to be played along with the said audio track in the musical performance, as part of the performance effects;
determining, in near real-time, a tempo value of the said video file based on the received information thereabout;
processing the said video file to determine required playback speed adjustment therefor to cause the tempo value of the said video to be in sync with the determined tempo value of the said audio track; and
playing the said video file with the required playback speed adjustment applied thereto, along with the audio track in the musical performance.

In another aspect, the present disclosure provides, a system for synchronizing performance effects with a musical performance, the system comprising:
an audio application programming interface (audio API) configured to receive, from a music application, a MIDI signal representing an audio track currently being played in the musical performance;
a memory having a library of video files stored therein;
a user interface adapted to allow a user to select a video file, from the library of video files, selected to be played along with the said audio track in the musical performance, as part of the performance effects; and
a processor configured to:
   determine, in near real-time, a tempo value of the said audio track based on a corresponding clock speed information as obtained from the MIDI signal;
   determine, in near real-time, a tempo value of the said video file based on information thereabout; and
   process the said video file to determine required playback speed adjustment therefor to cause the tempo value of the said video to be in sync with the determined tempo value of the said audio track; and
a display configured to play the said video file with the required playback speed adjustment applied thereto, along with the audio track in the musical performance.

The present disclosure relates to a system and a method for synchronizing performance effects with a musical performance. It may be contemplated that in order to provide a rich experience to the viewers, performers such as, but not limited to, musicians often use some performance effects with their musical performance. Herein, the performance effects include, but are not limited to, controlling a video file, camera feed switching, triggering actions, and the likes. In the present embodiments, the performance effect may include playing a video file in sync with audio (music) currently being played in the musical performance; and thus, herein, the performance effects may be the visual effects due to the video file being played.

There are a number of techniques for synchronizing performance effects with the musical performance. Typically, a time mode may be employed. Herein, a software application may be installed on a computing device that may synchronize performance effects with the musical performance by adjusting a time duration of the video file according to a tempo value of an audio track being played. It may be understood that different audio tracks may have different tempo values. Hence, according to the tempo value of the audio track, the video file selected may be time-stretched so as to match with the tempo of the audio track. The time mode is generally employed for manually synchronizing the video file with the audio track. However, the manual way of changing the tempo value of the video file may be erroneous and exhausting. The present disclosure provides the method and the system for synchronizing performance effects with the musical performance that apart from having the time mode where the tempo value of the video file is changed manually, it also has a beats per minute (BPM) mode.

The system comprises an audio application programming interface (audio API) configured to receive, from a music application, a MIDI signal representing an audio track currently being played in the musical performance. The application programming interface is an interface that facilitates communication between two software applications. The music application may be any application such as, but not limited to, a DJ (disc-jockey) software. Herein, the audio track currently being played may be some music or a song such as, but not limited to, a live music, an audio song file being played through the music application, vocals and an orchestra, being played currently in the musical performance. The audio tracks currently being played may generate signals such as, the MIDI signal representing the BPM of the audio tracks. The audio API of the present system may communicate with the music application to receive the MIDI signal representing the audio track currently being played in the musical performance. In other examples, the audio API of the present system may communicate with the music application to receive other types of signal, such as open sound control (OSC) and the likes; and hereinafter, the term “MIDI signal” has been used to broadly cover all such types of signals which may represent an audio track. It may be appreciated that the “MIDI” signal stands for musical instrument digital interface signal, which is a technical standard widely used in music industry. The MIDI signal may be used for, but not limited to, controlling the electronic digital musical instruments. Moreover, the musical instruments may also communicate with each other by using the MIDI signal.

The system comprises a memory having a library of video files stored therein. The library of video files may be a package of hundreds or even thousands of videos files that may be stored in a media folder. Herein, first, a plurality of video files may be accumulated and may be categorized into themes such as, Abstract Legacy, Blister Packs Legacy, Christmas, Countdown Legacy, Earth And Globes Legacy, Explosions, Halloween, Music And DJs Legacy, New Year's Eve, Specialty Themes Legacy, Static, Subtle Abstract, Subtle Abstract Legacy, Virtual Stages And Wedding And Worship, to name a few. In a PC operating system, a separate folder may be made for each theme and a tag may be associated with each folder that may denote the theme of the respective folder. The themes may be then further categorized into directories or collections. For example, in an embodiment, the media folder named as the “Complete Legacy” may be categorized into theme collections such as “Holidays” and then into collections such as, “Halloween” and the likes. Each individual collection may contain the video files related to it and the tag associated with the corresponding video file may provide metadata information about the video file.

The system comprises a user interface adapted to allow a user to select a video file, from the library of video files, selected to be played along with the said audio track in the musical performance, as part of the performance effects. The user interface may be any means that may be employed by the user to communicate with a computing device such as, a computer, a laptop and the likes. In order to select the video file from the library of video files, the user may click on a graphical user interface (GUI) or an internal control hotkey via a keyboard, or via an external control signal such as a MIDI note signal. It may be appreciated that the tagging of the video files in the library of video files helps in easy access of the video file to be played. For example, when the audio track being played is a rock music, then the theme corresponding to the rock music may be selected by going through the tags. Thus, the user may identify and play a number of video files related to the rock music directly without having to download and select the files one by one.

It may be noted that the video file may be selected beforehand by creating the playlist of the videos to be played in the musical performance or the video file may be selected live during the musical performance. For example, in an embodiment, when the musical performance is a rock music performance, the user may create the playlist of video files to be played in the musical performance beforehand. Herein, the video file to be played along with the said audio track in the musical performance may be selected beforehand. In alternative embodiment, the user may select the video file to played on-the-fly during the musical performance. In either case, the information about the video files may be received and the selection may be done through the user interface in the system.

Optionally, the user interface of the system may be further adapted to automatically tag the video files in the library of video files, as stored in the memory, based on metadata associated therewith, to facilitate selection by the user of the video file to be played along with the said audio track in the musical performance, as part of the performance effects. It may be understood that, the video files in the library of video files may not be tagged properly. Herein, based on the metadata of the video files, the video files may be tagged automatically through the user interface. For example, for the video file with the metadata suggesting that it is related to dance music, the video file may be tagged as “Dance Music” or the like. Similarly, for the video file with the metadata suggesting that it is soft and slow, the video file may be tagged as “Soul Music” or the like.

As discussed in the preceding paragraphs, the tagging of the video files may help in categorizing the video files in the library of video files according to their respective themes and collections. It may be appreciated that different audio tracks may have different tempo values. Hence, based on the tempo value of the audio track currently being played, the video file(s) have to be selected for synchronizing performance effects with a musical performance. For example, when the audio track having fast tempo is currently being played, then the video file(s) to be played along therewith may be from themes which suggest fast tempo. The tagging helps the user to easily determine which video file may suit the audio track being played. Thus, the tagging of video files eliminates the need to preview the video file in order to identify its theme. The user may just read the tag of the video file in order to get an idea of its theme.

Optionally, the user interface of the system is further adapted to allow the user to manually tag the video files in the library of video files, as stored in the memory. Many a time, the user may import video files which may not have any or relevant metadata associated therewith. In such case, it may be required that the user may tag such video files manually according to the theme that the user wishes to create. In some examples, such manual tags may be discrete, like “Rock”, “Metal” and the like. In other examples, the user may simply tag the video files manually under “Theme 1”, “Theme 2” and so on, as per his/her preference.

In an embodiment, the user may tag the video files in the library of video files as their favorite. For example, during the musical performance, if the user has any favorites, the user may tag the respective video file as “favorite”. In this way, if the user at any time wishes only to play their favorites, the GUI related to the favorite tag may be clicked that may recall all of the favorites of the user to be queued/played. In alternative embodiment, the user may tag the video files in the library of video files by a “do not play” tag. Such “do not play” tag may be exact opposite to the favorite tag. As, the name suggest, the user may tag the video as “do not play” when the user encounters a video playing on the screen that the he/she may not like and may not want the same to be played again. In this way the user may not have to delete such video files from the storage medium, and thus could retain those while still not encountering those during selection steps.

The system comprises a processor configured to determine, in near real-time, a tempo value of the said audio track based on a corresponding clock speed information as obtained from the MIDI signal, determine, in near real-time, a tempo value of the said video file based on information thereabout and process the said video file to determine required playback speed adjustment therefor to cause the adjusted tempo value of the said video to be in sync with the determined tempo value of the said audio track. Herein, the processor may determine, in near real-time, the tempo value of the said audio track based on the corresponding clock speed information as obtained from the MIDI signal. The tempo value of the audio track may represent its speed. It may be defined as number of beats per minute (BPM) in the said audio track. It may be contemplated that the MIDI signal may not be an audio signal. The MIDI signal may only transmit the information such as, but not limited to, a notation, a pitch, a velocity, a vibrato and the clock speed information of the said audio track. The clock speed information also known as a clock signal may help in determining the tempo value of the said audio track. The processor may determine the tempo value based on the clock speed information.

The processor further determines, in near real-time, the tempo value of the said video file based on information thereabout. Herein, the tempo value of the said video file refers to a native tempo value of the said video file, which may be determined from the information received about the selected video file. If the information about the tempo value of the said video file is not present, it may be calculated by using the value of video duration and applying an algorithm to determine its tempo value therefrom. Generally, there are currently two algorithms for such purpose. In one example, each of the two algorithms may be selected by user according to his/her preference. In another example, the system can be set to “auto-select” the algorithm based on a tempo value as entered by the user. Here is an example of code for one of the algorithms, as described below.

//takes in total time duration of video file and systemBPM and returns
BPM of the video file.
public double GetAutoBPM(double totalLength, double systemBPM)
{
double lengthlnBeats = totalLength / (60.0 /systemBPM); //get total
number of beats at the current BPM
double tempoAdjust; //value that will be used to adjust the current BPM to
derive the videos BPM
if (lengthlnBeats < 4) //less than 1 measure quantize to nearest quarter note
{
double wholeBeatsNum = Math.Pound(lengthInBeats); // round to closest
whole number
tempoAdjust = lengthlnBeats / wholeBeatsNum; //divide length in beats by
closest whole number to get adjustment value.
}
else if (lengthlnBeats < 16) //quantize to nearest measure
{
double lengthlnMeasures = lengthlnBeats / 4.0;
double wholeMeasuresNum = Math. Round(lengthInMeasures);
tempoAdjust = lengthlnMeasures / wholeMeasuresNum;
}
else //quantize to nearest 4 measure block
{
double lengthln4Measures = lengthlnBeats / 16.0;
double whole4MeasuresNum = Math.Round(lengthln4Measures);
tempoAdjust = length ln4Measures / whole4MeasuresNum;
}
return systemBPM / tempoAdjust; // divide system BPM by adjustment
value to get BPM of video.
}

It may be understood that, the tempo value of the selected video file may not always match with the tempo value of the audio track currently being played. In such case, the tempo value may be tweaked so that it matches with the tempo value. Otherwise, the video file would not play in synchronization with the audio track, i.e. the performance effects would not be synchronized with the musical performance.

In the present system, the processor further processes the said video file to determine required playback speed adjustment (hereinafter, sometimes also referred to as “time adjustment” or “time stretching” without any limitations) therefor to cause the adjusted tempo value of the said video to be in sync with the determined tempo value of the said audio track. As discussed in the preceding paragraph, the tempo of the video file may not match with the tempo value of the audio track. Hence, the video file playback speed may be adjusted. For example, in an embodiment, the video file may have a calculated tempo of 70 BPM and the audio track may be 140 BPM. Herein, the playback speed adjustment required may 200%. Thus, the playback speed of the video file may need to be adjusted by increasing its speed 2× so that it matches the tempo of the audio track.

It may be appreciated that in BPM mode, the video files may be time-stretched in order to match with tempo value of the audio track. Herein, the time-stretching means speeding-up or slowing-down the video file based on the tempo value of the video file. Herein, a frame blending may be used to help reduce the jittery affect when the videos file is slowed down to a lower frames per sec. For the sake of understanding, in time mode, “time” is measured and adjusted in seconds. In BPM mode, “time” is relative to tempo and adjusted in measures, beats and 64th notes. For example, 1.2.2 would be the duration equal to 1 measure, 2 beats and a 32nd note.

Optionally, determining the tempo value of the said audio track comprises determining a time signature value and a measure value for the said audio track, and wherein determining the required playback speed adjustment for the said video file comprises determining required change in at least one of a time signature value and a measure value for the said video file to match the corresponding one of the determined time signature value and measure value for the said audio track. The time signature value may provide information on how the music is counted. Generally, the time signature value is represented in the form of a fraction. For example,

$$the time signature value = \frac{X}{Y}$$

Herein, ‘X’ denotes the number of beats to be counted, and may take any number value between 2 and 12; ‘Y’ represents a kind of note to be counted. Herein, when ‘Y’ is taken as 1, it means whole of the note may be counted which does not happen generally. When ‘Y’ is taken as 2, it means half note may be counted. When ‘Y’ is taken as 4, it means quarter note may be counted. When ‘Y’ is taken as 8, it means eighth note may be counted. When ‘Y’ is taken as 16, it means sixteenth note may be counted.

Typically, 4/4-time signature is most popular in the dance music. Hence, herein, the beat may be counted as 1,2,3,4,1,2,3,4 and so on. The measure value is a group of beats present in a segment of time. The number of beats in the group of beats may be stated by the time signature value. Herein, each beat may represent a note value. Determining the tempo value of the said audio track may comprise determining a time signature value and a measure value for the said audio track. Hence, in order to determine the required playback speed adjustment for the said video file, the change in at least one of the time signature value and the measure value for the said video file may be determined so that the time signature value and the measure value matches the determined time signature value and measure value for the said audio track.

The system comprises a display configured to play the said video file with the required playback speed adjustment applied thereto, along with the audio track in the musical performance. As discussed, the tempo of the video file may not match with the audio track. Hence, it may be necessary to time-stretch the video file. It may be noted that, the system and the method of the present disclosure do not generate a new video file by time stretching and then playing it. Rather, the system and the method of the present disclosure time stretches the video file directly and plays it on the display. This is so because, the generation of new time adjusted video file may need transcoding that may be complicated and computing intensive.

It may be further noted that, the time stretching of the video file may not be done only based on the difference in time of the audio track and the video file. Rather, the time adjustment may be primarily done on the basis of the difference in the audio tempo value and the tempo value of the video. That is, the time stretching may be done on the basis of the difference in speed between the video file and the audio track. For example, in an embodiment, the video file may be of 30 BPM seconds and the audio file may be of 90 BPM. The graphics of the video file may be slower than the audio file. Hence, herein, the video file of 30 BPM may be converted into 90 BPM by increasing the playback speed by 300%.

It may be understood that the tempo value of the audio track may not be constant throughout, rather the tempo value may vary. For example, the audio track may be of 90 BPM and the video track may also be of 90 BPM. However, for the audio track there may be a lot of variation in the tempo value. The first 10 seconds of the audio track may have the tempo value as constant and the next 80 seconds may have the tempo values as constant and different from the first 10 seconds. The first 10 seconds of the audio may be “slow” and the rest 80 seconds may be “fast”. Hence, the video file may be time stretched automatically in real time as the audio tempo changes. The first 10 seconds of the video file may be made slower so that it synchronizes with the first 10 seconds of the video file. The next 80 seconds of the video file may be made faster from its tempo value by time stretching so that it matches with the next 80 seconds of the audio track.

Optionally, the processor is further configured to adjust a transition time between the said video file to a next video file selected to be played along with the said audio track in the musical performance, as part of the performance effects, based on the determined tempo value of the said audio track. The transition time may be defined as the time taken by the said video file to switch to the next video file selected to be played along with the said audio track. The transition time may be determined based on the tempo value of the said audio track. For instance, if an audio track with “fast” tempo value is being played, the transition time may be set as 1 second. That is, after completion of playback of first video file, then a transition effect may be played for 1 second, and the next (queued) video file may be played. In another instance, if an audio track with “slow” tempo value is being played, the transition time may be set as 3 seconds. That is, after completion of playback of first video file, then a transition effect may be played for 3 seconds, and the next (queued) video file may be played. In one or more embodiments, the transition may be applied on the beat and synchronized to the audio tempo. For example, a transition may be set to completed in exactly 8 beats according to the audio tempo representing the MIDI signal so that the said video file transitions to the next video file on the said beat.

Optionally, the system further comprises a camera application programming interface (camera API) configured to communicate with one or more cameras to receive multiple video streams related to the musical performance therefrom, wherein the processor is further configured to play at least one video stream from the multiple video streams along with the said audio track in the musical performance, as part of the performance effects and switch to at least one other video stream from the multiple video streams based on the determined tempo value of the said audio track. Herein, the camera application programming interface (camera API) enables to communicate with the one or more cameras. That is, each of the cameras may send video streams related to the musical performance to the system via the camera API, with the display of the system being capable of playing at least one video stream at any given instant as part of the performance effect as per the embodiments of the present disclosure.

In one example, the one or more cameras may be installed inside or outside a venue of the musical performance. In another example, the one or more cameras may include two cameras placed in two locations inside the venue. A first camera may be placed in such a way that it focusses on the audience and the second camera may be placed focussing on the musicians. Initially, the video stream from the first camera may be played along with the said audio track. When there is variation in the tempo value of the said audio track, the video stream may be switched to the one received from the second camera. Hence, switching between the video streams may be done on the basis of the tempo value of the said audio track. It may be appreciated that when the said audio track being played is “slow”, the system may play one video stream for some time before switching to the other. Similarly, when the said audio track being played is “fast”, the system may switch the video streams rapidly. Thus, the performance effect may be displayed in such a way that the video streams from multiple cameras may be switched according to the tempo value of the said audio track, so that the actions of the musicians and the corresponding reactions of the audience may be shown alternatively.

Optionally, the processor is further configured to adjust event envelopes including one or more of panning, volume control, fade-in type and fade-out type of the said audio track, as part of the performance effects, based on the determined tempo value of the said audio track. In an embodiment, a common style “Attack-Delay-Sustain-Release” (ADSR) envelopes may be implemented to control common parameters in each of Grid Layers, Effects Layers, Camera Layers, Spout/NDI Layers and Browser Layers. Currently the envelope is hardwired to the transition time of the video grid, browser and camera layers. Herein, the envelope controls the strength of the effect assigned in the effect layer. For instance, in a zoom effect, its strength controls the length of the “zoom rays” created when the effect is active. Using the envelope to control that effect parameter allows the ray length to pulse according to a rhythm of the music when in BPM mode. In the present implementations, there is an envelope trigger mode for each envelope: Play Once, Hold and Toggle, in which ‘Play Once’ forces the envelope to go all the way through once time even if the trigger is only held for part of that time, ‘Hold’ requires the trigger button to be held to progress through the envelope and when the trigger is released, the envelope begins the ‘Release phase; and ‘Toggle’ has similar behaviour as Hold but will keep the trigger depressed until a second trigger is received. In some examples, ‘Interpolation Modes’ are also available, such as Flat, Triangle, Sine and Square. This determines the way the envelope is shaped at the ADR section points. Since the envelopes can be set to adjust each section's duration (attack time, decay time and release time) the envelope can be set in BPM mode to sync with the audio similar to the duration and transition settings. In some implementations, the system also employs “freely assignable envelopes” to be routed to any assignable parameter in the entire interface, similar to the way hotkeys, MIDI and FFT are assigned.

It may be appreciated that the envelopes of the present disclosure are similar as in typical music software. An example may be an ADSR with “Repeat” parameter. Herein, the envelopes may have a sustain level value associated with it. The strength value indicates the maximum amount of change that the envelope applies to a target parameter in the attack stage. That is, the strength value (which may vary between 0-100%) determine how much effect the ADSR will have on the target parameter. At 0% no effect will be noticed. At 100% it will vary the target parameter greatly. Other parameter in the ADSR include an attack time, a decay time, sustain level and a release time, in which the attack time is the time it takes to ramp up to the strength value, the sustain time is the time it holds the sustain level, and the release time is the time that will elapse from the sustain level to 0 once trigger button is released.

It may be noted that a list of transition styles for the queued video files may be created. For example, the list of transition styles may comprise the Fade, Circle Open and a Cube Spin to transition between videos. For example, when the first video file transitions to second video file, the Fade style is used; and when the third video file is played as part of the queue, the Circle Open is used. This may continue till the last transition in the list, and then it may loop back to the first transition style in the list. So, each time there is transition between videos, the next transition style in list of transitions is executed. In this way various transition styles may be executed during a live musical performance without having to set them manually or on a timer. If the user doesn't like any of transition styles in the list, the user may disable those. The disabled transition styles will be skipped when encountered in the list.

Optionally, the processor is further configured to trigger events including one or more of generating theatrical smoke, generating theatrical fog and controlling lights, as part of the performance effects, based on the determined tempo value of the said audio track. The theatrical smoke and theatrical fog may be a type of atmospheric effects used in entertainment industries which are generated, herein, based on the tempo value of the said audio track. The lights may a type of visual effects used in the entertainment industry, and may involve controlling the light based on the tempo value of the said audio track. Generating theatrical smoke and theatrical fog and controlling lights may help in setting a sense of mood in the musical performance. For example, when there is a sudden change in tempo value of the said audio track, the theatrical smoke may be generated suddenly to match the tempo value of the said audio track. Similarly, when the said audio track is slow, the theatrical fog may be generated slowly in synchronization with the tempo value of the said audio track. Further, when the said audio track is fast, the lights may be controlled to change rapidly in accordance with the tempo value of the said audio track.

Optionally, the user interface of the system is configured to allow manual adjustment, by the user, of a duration of playback of the said video file and a transition time to switch from one video file to another video file, selected to be played along with one or more audio tracks in the musical performance. As discussed, the manual adjustment of the duration of playback of the said video file may be done by the time mode. In order to facilitate manual adjustments a time control button and a transition time control button may be provided. The time control button may be the graphical user interface (GUI) element that indicates and allows to change how long each video file plays before it shifts to the next video file in the playlist may be provided. In an example, the duration time may be set to 10 seconds that may be highlighted in the time control area, indicating that the video file would play for time duration of 10 seconds before switching to next one in the playlist. However, if a user wishes to change it, the user may click in the time control area and a new value may be entered as desired. Hence, according to the tempo of the audio track being currently played, the tempo of the video file being currently played may be altered by using the duration time control area.

Further, the user interface may provide a transition time control area which may be a GUI used to indicate how many seconds or minutes it would take to transition between two video files. In an example, the transition time may be set to 2 seconds that may be highlighted on the transition control area, indicating that the transition effect would play for time duration of 2 seconds before switching to next video file. However, if a user wishes to change it, the user may click in the transition time control area and a new value may be entered as desired.

In an embodiment, the user interface may provide an audio assignment feature. The audio assignment feature may allow for selection of one or more frequency bands of the audio track to change a state of user interface controls throughout the user interface based on a level of that frequency. When assigned to a GUI, such as a button, an audio level threshold may be set; and when crossed, may trigger that button. When assigned to an encoder, knob, menu pull-down, or slider, a range may be set and controller may follow the level of the audio track at the selected frequency when entering a specified range. Other settings including speed, normalize and minimum level, may be used to fine tune a FFT algorithm to create a most useful output based on a style of the audio track and the selected frequencies.

In order to execute the audio assignment feature, an effects layer may be added in the user interface. Herein, once the audio track is played, a GUI for selecting an effect from a plurality of effects may be selected. The plurality of effects may include color flash, pixels, zoom, bulge, shake, cube and the likes. For instance, in case of color flash, the color flash effect as well as color of flash may be selected (e.g. white) by selecting a color flash GUI on the effects layer. Next, the user may right click on any GUI such as, control or buttons throughout the user interface usually, a MIDI key, a PC keyboard hot key assigned for selecting the audio assignment feature. An audio assignment GUI may be selected, following which, a spectrum analyser dialogue box may appear on the user interface. Therefrom, a frequency band may be selected. It may be noted that user could also select multiple frequency bands. In some embodiments, an audio track threshold GUI comprising a bar that could be moved (slide) up and down for selecting an audio track threshold may be employed. In some examples, compression and normalization type controls such as speed, normalize, minimum level and threshold may be provided to smooth out triggering based on type of audio track being played. Once, the audio track threshold and the compression and normalization type controls are set, the audio assignment feature may be turned ON. Subsequently, when the frequency band hits the audio track threshold, selected effect is displayed (e.g., white background may be flashed on the screen if white color flash effect may have been selected). The color flash of white color may be tied to the envelopes. For example, on setting a ‘release’ value as zero, the color flash as, say, white screen may pop right off. Similarly, on increasing an ‘attack’ value, the user interface may ramp up the color flash rather than just popping the color flash as white screen.

The present description also relates to the method for synchronizing performance effects with a musical performance as described above. The various embodiments and variants disclosed above apply mutatis mutandis to the method for synchronizing performance effects with a musical performance.

Optionally, the method further comprises adjusting a transition time between the said video file to a next video file selected to be played along with the said audio track in the musical performance, as part of the performance effects, based on the determined tempo value of the said audio track.

Optionally, the method further comprises receiving multiple video streams related to the musical performance, from one or more cameras; playing at least one video stream from the multiple video streams along with the said audio track in the musical performance, as part of the performance effects; and switching to at least one other video stream from the multiple video streams based on the determined tempo value of the said audio track.

Optionally, the method further comprises triggering actions including one or more of generating theatrical smoke, generating theatrical fog and controlling lights, as part of the performance effects, based on the determined tempo value of the said audio track.

Optionally, determining the tempo value of the said audio track comprises determining a time signature value and a measure value for the said audio track, and wherein determining the required playback speed adjustment for the said video file comprises determining required change in at least one of a time signature value and a measure value for the said video file to match the corresponding one of the determined time signature value and measure value for the said audio track.

The system and method of the present disclosure provide real-time time-stretching of videos to match the tempo of music playback using BPM detection algorithms. The present system and method also provide tagging videos inside of a real-time playback engine. The present system and method also provide real-time video playlist changes based on tag selections. The present system and method further provide natively integrating a large video library directly inside of a software product.

It may be noted that the system and the method of the present disclosure may be utilized as a performance control application for live stage and streaming performers. At its core, the performance control application may be a playback engine that automatically synchronizes video files, preset transitions and effects to the tempo value in real-time, making the musical performance unique and always matching to the beat. The performance control application may be used to adjust all parameters such as, the adjusted video tempo value using the time mode or may be used in the BPM mode that perfectly tracks the musical performance and enters time in measures and beats. The performance control application may include a MIDI, hotkey and Fast Fourier Transform (FFT) assignable interface for flexible control and sequencing of favourite parameters of the user. The performance control application may be used to import their own video files or bundled with the library of video files for instant integration of 6 thousand (or more) video files pre-organized and pre-tagged according to themes, energy levels, native video tempo values and more. The performance control application may be used to manually tag the video files that may help the user to organize the video files unique to the way he/she wishes to perform. Then, the user may directly access the video files playback from the performance control application during their musical performance for instant recall of the video file that the user wants to play in real-time at the click of the mouse, keyboard hotkey or MIDI button.

The system and the method of the present disclosure may be implemented in a number of applications. For example, the present system may be implemented in a way to manually trigger videos from the playlist for theatre and other production environments. The present system may also be implemented in a way to use as a green screen tool for stage, corporate and streaming presentations, with green screen chromakeying being one of many effects that may be included in the present system. The present system may also be implemented in a way to provide visual themes for any kind of venue, e.g. as animated artwork in lobbies and as a branding or marketing tool using a logo switcher feature. The present system may further be implemented in a way to use external control devices such as, MIDI controllers, OSC controllers, motion detection sensors and the likes to change parameters within the user interface for interactive installations and live experiences. The present system may further be implemented in a way to automatically switch between any number of cameras plugged in and routed to the main output or through effects layers. The present system may furthermore be used as a secondary source routing to other software on a network using its Spout and NDI implementation. For this purpose, present system may have a server version with additional features including a “scheduler” that can automatically change parameters, pre-sets and playlists at specific times and dates.

The present system and the method are advantageous as the performance effects with the musical performance may be synchronized efficiently and instantly in real time without much manual calculation and without dropping any video frames in the video file. The present system is designed to use low computing resources such that it may be used on the same computing device where the performer music or DJ application is running. Thus, the system and the method may not require a dedicated person (team member) with a separate computing device.

### DETAILED DESCRIPTION OF THE DRAWINGS

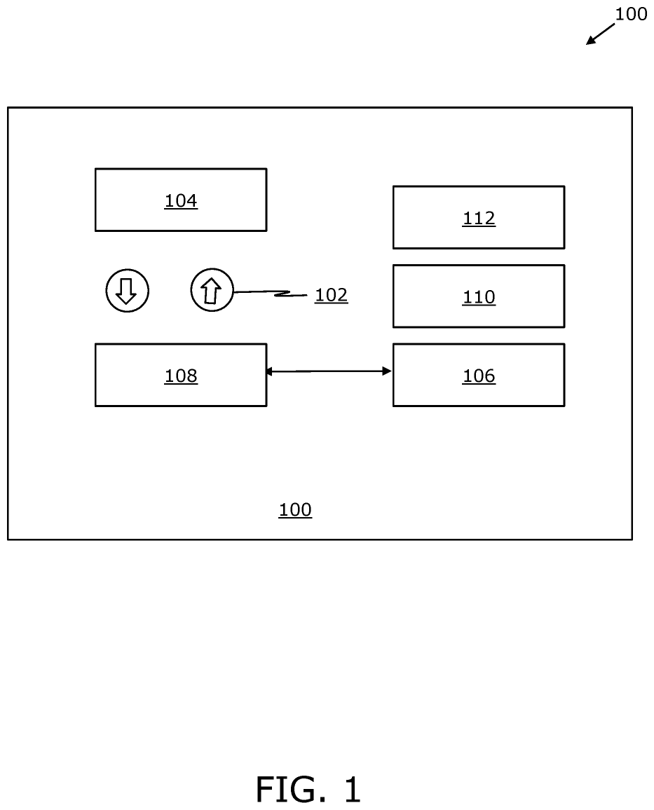

Referring to FIG. 1, there is shown a block diagram illustration of a system 100 for synchronizing performance effects with the musical performance, in accordance with an embodiment of the present disclosure. The system 100 comprises an audio application programming interface (audio API) 102, the music application 104, the memory 106, the user interface 108, the processor 110 and the display 112. The audio API 102 is configured to receive, from the music application 104, the MIDI signal representing the audio track tempo currently being played in the musical performance. The memory 106 has a library of video files stored therein. The user interface 108 is adapted to allow the user to select a video file, from the library of video files, selected to be played along with the said audio track in the musical performance, as part of the performance effects. The processor 110 is configured to determine, in near real-time, a tempo value of the said audio track based on a corresponding clock speed information as obtained from the MIDI signal, determine, in near real-time, a tempo value of the said video file based on information thereabout and process the said video file to determine required video playback speed adjustment therefor to cause the adjusted tempo value of the said video to be in sync with the determined tempo value of the said audio track. The display 112 is configured to play the said video file with the required playback speed adjustment applied thereto, along with the audio track in the musical performance.

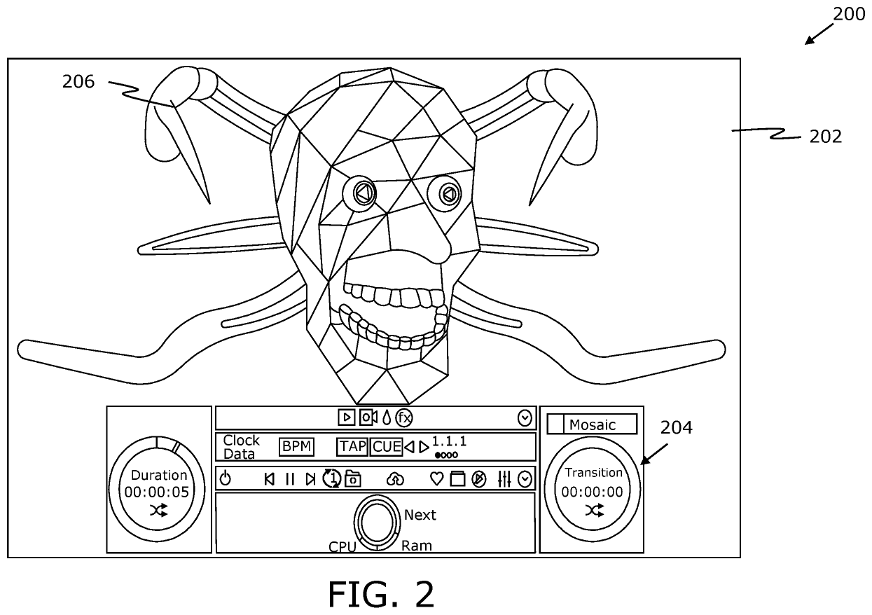

Referring to FIG. 2, there is shown a diagrammatic illustration of a user interface 200 for synchronizing performance effects with the musical performance, in accordance with an embodiment of the present disclosure. The user interface 200 may be a playback engine executed in a display 202. The display 202 is configured to play the video file. In the illustrated example, the video file has a Halloween theme with a ghost FIG. 206 appearing on the display 202. The user interface 200 provides a control panel 204.

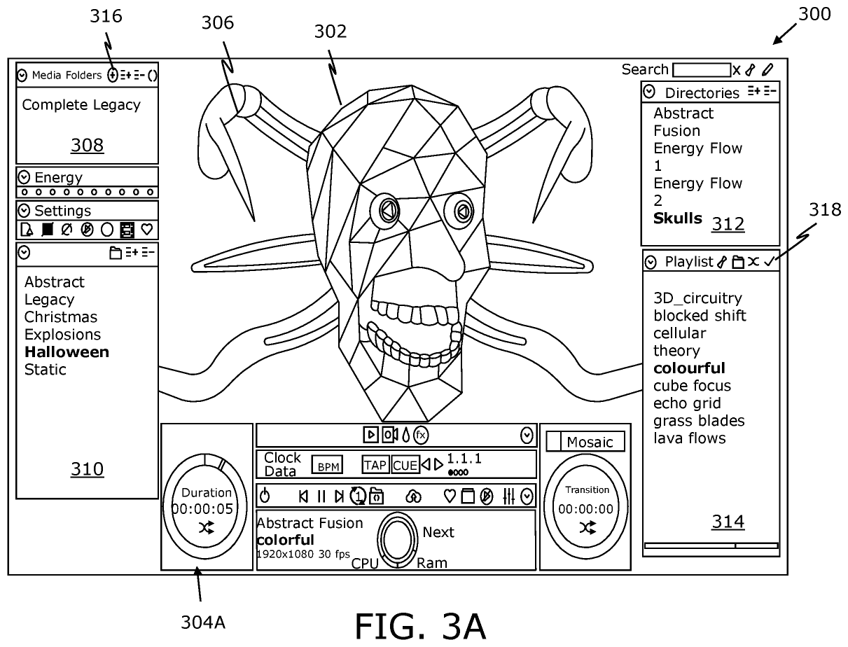

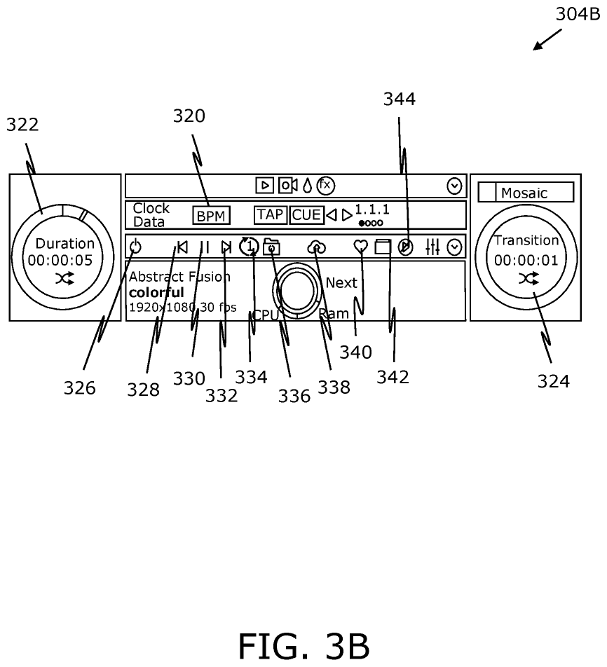

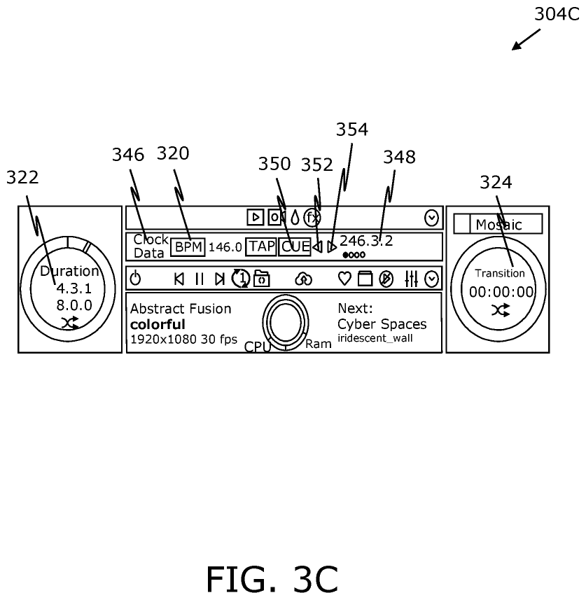

Referring to FIG. 3A, there is shown a diagrammatic illustration of the user interface of a media browser 300 for managing video files and for synchronizing performance effects with the musical performance, in accordance with an embodiment of the present disclosure. The user interface comprises the display 302, the control panel 304A, a media folder block 308, themes block 310, directories block 312 and a playlist 314. The media folder block 308 provides various folders; herein, a “Complete Legacy” folder. More folders may be added to the media folder block 308 by utilizing a GUI element 316. The themes block 310 provides a list of themes such as, Abstract Legacy, Christmas, Explosions, Halloween and Static that are present in the complete legacy theme of the media folder 308. In the illustrated example, a video from the Halloween theme is playing on the display 302. The Halloween theme is selected by clicking on it and hence, it is highlighted. The directories block 312 provides a list of directories such as, Abstract Fusion, Energy Flow 1, Energy Flow 2 and Skulls. Herein, the Skulls directory is selected and hence it is highlighted. The playlist block 314 provides a list of video files in the selected directory. Initially when the one or more directories are selected from the directories block 312, their respective video files appear in the playlist. One or more video files may be removed from playback if the user does not like it. The playlist may be approved by clicking a GUI element 318. The video file (herein, colorful) that is currently playing is highlighted.

Referring to FIG. 3B, there is shown a diagrammatic illustration of a control panel 304B for synchronizing performance effects with the musical performance in the time mode, in accordance with an embodiment of the present disclosure. The control panel 304B comprises a mode control button 320, a duration control area 322, a transition time control area 324, and playback controls 324-344. The playback controls include a power button 326, a rewind button 328, a pause play button 330, a forward button 332, a loop button 334, a folder freeze button 336, a stream button 338, a favorites button 340, a logo folder button 342 and a do not play tag button 344.

Herein, the mode control button 320 is used to change the mode. As discussed, there may be two modes for synchronizing performance effects with a musical performance, i.e. a time mode and a “beats per minute” (BPM) mode. Herein, the mode is set to time mode. In order to switch to the BPM mode, the mode control button 320 have to be clicked. The time control area 322 indicates how long each video file plays before it transitions to the next video file in the playlist. The transition time control area 324 indicates how many seconds or minutes it is set to transition between two video files.

The power button 326 is used to disable the main video player output. When turning off, the display 302 may fade to black and the counter in the time control button 322 and the transition time control button 324 may stop. The user interface may be activated by clicking the power button 326 again. The rewind button 328 may move the selected video file up in the playlist 314. The pause play button 330 lets the user to play and pause the video file. The forward button 332 instantly moves to the next video file in the playlist 314. The loop button 334 loops the selected video file for indefinite time until it is unlopped. When a number of directories are selected in the directories block 312 and the folder freeze button 336 is clicked, then the directory from which selected video file is currently playing will freeze and only the video files from the said directory may play. In this way, the said directory is locked. It may be used when the user likes the video files from the said directory and feels that it fits with the vibe of the musical performance. It's an easy way to keep the theme consistent. The stream button 338 may be used to send the display output and audio to social media platforms. The favorites button 340 may be used to tag the video files that the music performer likes as their favorite. The logo folder button 342 may be used when the user wishes to display the logos placed in a specific folder, and provides a quick way of branding the music performance. The do not play tag 344 may be used to tag the videos that the user may not like so that those video files are not played again.

Referring to FIG. 3C, there is shown a diagrammatic illustration of a control panel 304C for synchronizing performance effects with the musical performance in the BPM mode, in accordance with an embodiment of the present disclosure. The BPM mode may be initiated by clicking on the mode control button 320 (as shown in FIG. 3B) by toggling to the BPM mode from the time mode. The control panel 304C includes the mode control button 320, the duration time control area 322, the transition time control area 324, a MIDI clock and MIDI data indicator 346, a beats elapsed indicator 348, a cue button 350, a nudge backwards button 352 and a nudge forward button 354.

The duration time control area 322 and the transition time control area 324 in the BPM mode displays as measures and beats. When MIDI signal of the audio track currently being played in the musical performance is received, the tempo value of the selected video file may be automatically adjusted in real time so that the selected video file synchronizes with the said audio track. The MIDI clock and MIDI data indicator 346 gives information about the MIDI signal received by the application. The beats elapsed indicator 348 indicates 4/4 time signature value. It basically shows the measures and beats since the last cue. The cue button 350 may be clicked to lock the duration and start over the count, and is used to cue up the videos at the one count in the musical performance. It is utilized to align the first beat of a measure in the audio with the start of video playback. Usually this may be used once per session. The nudge backwards button 352 and the nudge forward button 354 may be used when the video file playback is ahead or behind the audio track. This may happen when the MIDI clock has a delay or the user clicks the CUE button off beat.

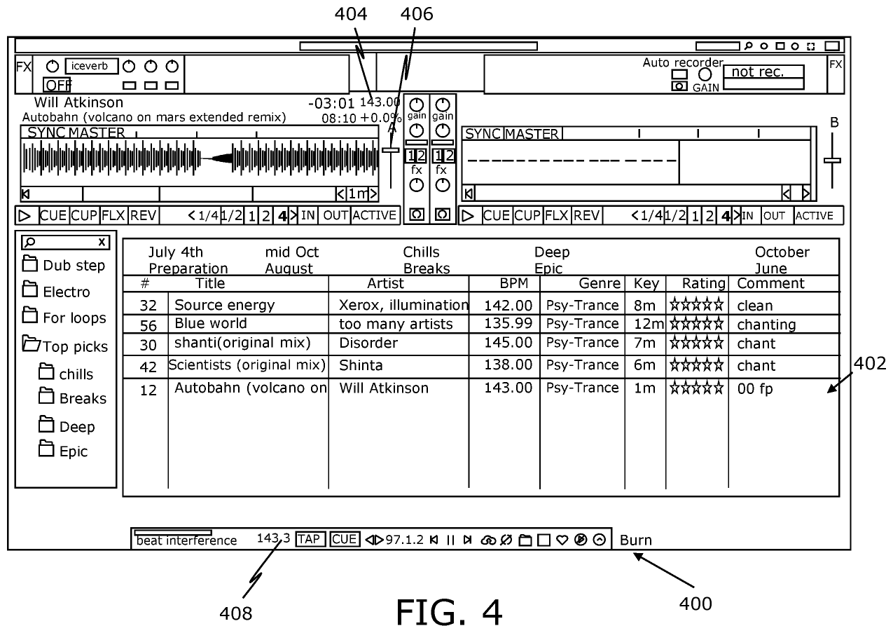

Referring to FIG. 4, there is shown a diagrammatic illustration of a user interface 400 for synchronizing performance effects with the musical performance in a micro-view form, in accordance with an embodiment of the present disclosure. Herein, the user interface 400 is minimized and is operating in the micro-view. A music application 402 that may be a DJ software is used to play the audio track. The MIDI clock representing the audio track tempo that is currently playing is displayed on the MIDI clock indicator 404. In the illustrated example, the BPM indicator 404 has the value of 143.00. The bar 406 may be moved up and down to change the tempo value of the said audio track. It may be seen that the MIDI clock and MIDI data indicator 346 of the user interface 400 also has the MIDI clock value as 143.00. Hence, the tempo value of audio track and the video file are in synchronization. It may be noted that in micro-view, the user interface 400 floats on top of the music application 402 to provide essential video stats at a glance without taking up much space and getting in the way of the music application 402. The idea allows the musicians or DJs to still focus on the musical performance.

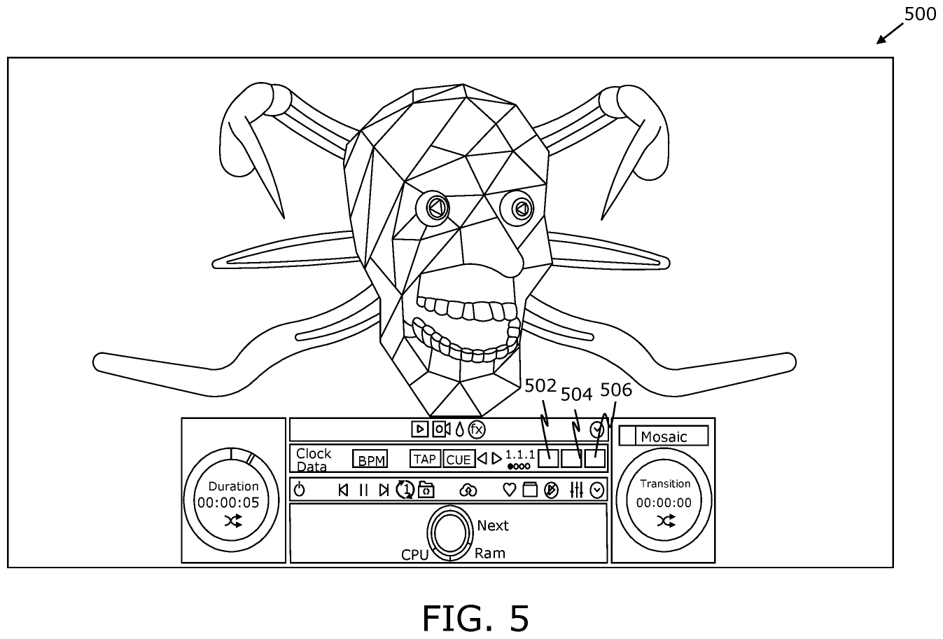

Referring to FIG. 5, there is shown a diagrammatic illustration of a user interface 500 for triggering actions, in accordance with an embodiment of the present disclosure. The user interface 500 is generally similar to the user interface 200 of FIG. 2. The user interface 500 further comprises a first button 502 for generating theatrical smoke, a second button 504 for generating theatrical fog and a third button 506 for controlling lights as part of the performance effects, based on the determined tempo value of the said audio track.

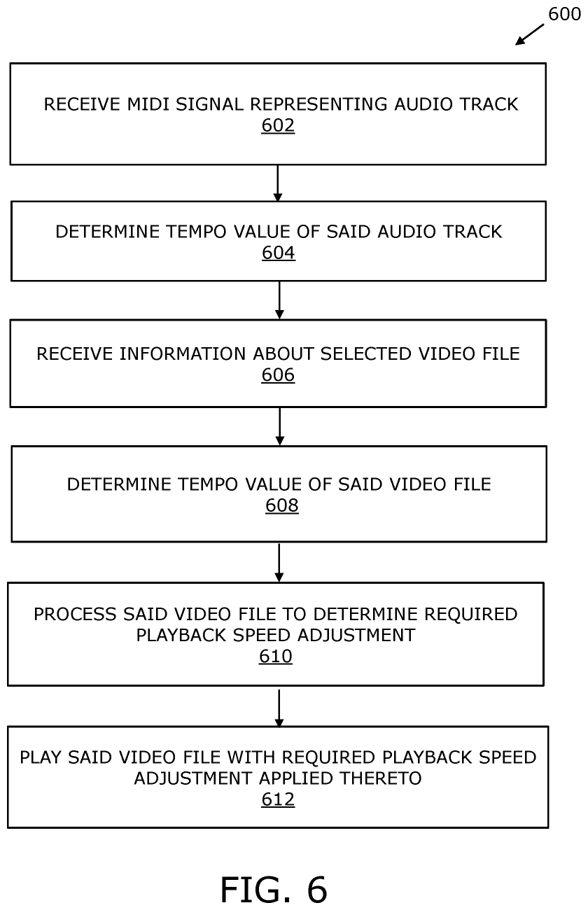

Referring to FIG. 6 there is shown a flowchart 600 listing steps of a method for synchronizing performance effects with a musical performance, in accordance with an embodiment of the present disclosure. The method comprises, at step 602, receiving a MIDI signal representing an audio track. Herein, the MIDI signal representing the audio track currently being played in the musical performance is received. The method comprises, at step 604, determining a tempo value of the said audio track. Herein, the tempo value of the said audio track based on a corresponding clock speed information as obtained from the MIDI signal is determined in near real-time. The method comprises, at step 606, receiving information about a video file selected. Herein, the information about the video file selected to be played along with the said audio track in the musical performance, as part of the performance effects is received. The method comprises, at step 608, determining a tempo value of the video file. Herein the tempo value of the said video file based on the received information thereabout is determined in near real-time. The method comprises, at step 610, processing the said video file to determine required playback speed adjustment. Herein, the said video file is processed to determine required playback speed adjustment therefor to cause the adjusted tempo value of the said video to be in sync with the determined tempo value of the said audio track. The method comprises, at step 612, playing the said video file with the required adjustment applied thereto, along with the audio track in the musical performance.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for synchronizing performance effects with a musical performance, the method comprising:
receiving a MIDI signal representing an audio track currently being played in the musical performance;
determining, in near real-time, a tempo value of the said audio track based on a corresponding clock speed information as obtained from the MIDI signal;
receiving information about a video file selected to be played along with the said audio track in the musical performance, as part of the performance effects;
determining, in near real-time, a tempo value of the said video file based on the received information thereabout;
processing the said video file to determine required playback speed adjustment therefor to cause the tempo value of the said video to be in sync with the determined tempo value of the said audio track; and
playing the said video file with the required playback speed adjustment applied thereto, along with the audio track in the musical performance.

2. A method according to claim 1 further comprising adjusting a transition time between the said video file to a next video file selected to be played along with the said audio track in the musical performance, as part of the performance effects, based on the determined tempo value of the said audio track.

3. A method according to claim 1 further comprising:
receiving multiple video streams related to the musical performance, from one or more cameras;
playing at least one video stream from the multiple video streams along with the said audio track in the musical performance, as part of the performance effects; and
switching to at least one other video stream from the multiple video streams based on the determined tempo value of the said audio track.

4. A method according to claim 1 further comprising providing a user interface for synchronizing performance effects with the musical performance in a micro-view form.

5. A method according to claim 1 further comprising triggering actions including one or more of generating theatrical smoke, generating theatrical fog and controlling lights, as part of the performance effects, based on the determined tempo value of the said audio track.

6. A method according to claim 1, wherein determining the tempo value of the said audio track comprises determining a time signature value and a measure value for the said audio track, and wherein determining the required playback speed adjustment for the said video file comprises determining required change in at least one of a time signature value and a measure value for the said video file to match the corresponding one of the determined time signature value and measure value for the said audio track.

7. A system for synchronizing performance effects with a musical performance, the system comprising:
an audio application programming interface (audio API) configured to receive, from a music application, a MIDI signal representing an audio track currently being played in the musical performance;
a memory having a library of video files stored therein;
a user interface adapted to allow a user to select a video file, from the library of video files, selected to be played along with the said audio track in the musical performance, as part of the performance effects; and
a processor configured to:
determine, in near real-time, a tempo value of the said audio track based on a corresponding clock speed information as obtained from the MIDI signal;
determine, in near real-time, a tempo value of the said video file based on information thereabout; and
process the said video file to determine required playback speed adjustment therefor to cause the tempo value of the said video to be in sync with the determined tempo value of the said audio track; and
a display configured to play the said video file with the required playback speed adjustment applied thereto, along with the audio track in the musical performance.

8. A system according to claim 7, wherein the processor is further configured to adjust a transition time between the said video file to a next video file selected to be played along with the said audio track in the musical performance, as part of the performance effects, based on the determined tempo value of the said audio track.

9. A system according to claim 7, wherein the user interface is configured to allow manual adjustment, by the user, of a duration of playback of the said video file and a transition time to switch from one video file to another video file, selected to be played along with one or more audio tracks in the musical performance.

10. A system according to claim 7 further comprising a camera application programming interface (camera API) configured to communicate with one or more cameras to receive multiple video streams related to the musical performance therefrom, wherein the processor is further configured to:
play at least one video stream from the multiple video streams along with the said audio track in the musical performance, as part of the performance effects; and
switch to at least one another video stream from the multiple video streams based on the determined tempo value of the said audio track.

11. A system according to claim 7, wherein the processor is further configured to provide a user interface for synchronizing performance effects with the musical performance in a micro-view form.

12. A system according to claim 7, wherein the processor is further configured to trigger events including one or more of generating theatrical smoke, generating theatrical fog and controlling lights, as part of the performance effects, based on the determined tempo value of the said audio track.

13. A system according to claim 7, wherein determining the tempo value of the said audio track comprises determining a time signature value and a measure value for the said audio track, and wherein determining the required playback speed adjustment for the said video file comprises determining required change in at least one of a time signature value and a measure value for the said video file to match the corresponding one of the determined time signature value and measure value for the said audio track.

14. A system according to claim 6, wherein the user interface is further adapted to automatically tag the video files in the library of video files, as stored in the memory, based on metadata associated therewith, to facilitate selection by the user of the video file to be played along with the said audio track in the musical performance, as part of the performance effects.

15. A system according to claim 6, wherein the user interface is further adapted to allow the user to manually tag the video files in the library of video files, as stored in the memory.
